(19) United States
(12) Patent Application Publication
(10) Pub. No.: US 2026/0361249 A1
(43) Pub. Date: Nov. 12, 2026

(54) VEHICLE MOTOR DRIVE DEVICE AND METHOD OF CONTROLLING SAME

(71) Applicants: Hyundai Motor Company, Seoul (KR); Kia Corporation, Seoul (KR)

(72) Inventors: Ji Gyun JEONG, Hwaseong-si (KR); Byung Kwan SON, Hwaseong-si (KR); Seok Min BAE, Hwaseong-si (KR); Yong Jae LEE, Hwaseong-si (KR); Jin Su HONG, Hwaseong-si (KR)

(73) Assignees: Hyundai Motor Company, Seoul (KR); Kia Corporation, Seoul (KR)

(21) Appl. No.: 19/365,567

(22) Filed: Oct. 22, 2025

(30) Foreign Application Priority Data
May 12, 2025 (KR) 10-2025-0061398

(51) Int. Cl. H02P 21/00; B60L 15/00; B60L 15/02; B60L 58/27; H01M 10/615; H01M 10/625; H01M 10/633; H01M 10/6571; H02P 27/06

(52) U.S. Cl. CPC H02P 21/50; B60L 15/007; B60L 15/02; B60L 58/27; H01M 10/615; H01M 10/625; H01M 10/633; H01M 10/6571; H02P 27/06; H01M 2220/20

(57) ABSTRACT

In a vehicle motor drive device and a method for controlling the same, the vehicle motor drive device includes an inverter including a plurality of switching elements and connected to each winding of a motor and a controller operatively connected to the inverter and configured to drive the motor by controlling the inverter and control the heat generation in the motor and the inverter when a vehicle is stopped.

### CROSS REFERENCE TO RELATED APPLICATION

The present application claims priority to Korean Patent Application No. 10-2025-0061398, filed May 12, 2025, the entire contents of which are incorporated herein for all purposes by this reference.

### FIELD OF THE PRESENT DISCLOSURE

The present disclosure relates to a vehicle motor drive device configured for efficiently driving a motor and a method for controlling the same.

### BACKGROUND

Chemical cells generating electrical energy through chemical reactions are mainly used for high-voltage batteries for electrified vehicles. In a case where such chemical cells are used at temperatures lower than an appropriate temperature, the battery output may be limited or the available capacity may decrease. Accordingly, a battery heater may be used to maintain a battery temperature at an appropriate level.

Furthermore, most electrified vehicles have a heating device for maintaining a vehicle interior at an appropriate temperature. A Positive Temperature Coefficient (PTC) heater, a heat pump system, a heater using a heating wire, or the like is mainly used for the heating device.

An alternating Current (AC) motor (i.e., an electric motor) widely used in electrified vehicles may be driven by use of electrical energy of a high-voltage battery as an energy source and receiving the input of AC power through an inverter. When AC current flows through motor windings, the electrical energy may be converted into kinetic energy by electromagnetic interaction between a stator and a rotor. Meanwhile, heat generation of the inverter and motor may occur due to the loss of electrical energy in a process of converting the electrical energy into the kinetic energy.

Accordingly, research is being conducted in the relevant field of technology on methods for controlling the heat generation of motors.

The foregoing is intended merely to aid in the understanding of the background of the present disclosure, and is not intended to mean that the present disclosure falls within the purview of the related art that is already known to those skilled in the art.

### BRIEF SUMMARY

Accordingly, an objective of the exemplary embodiment for solving the technical problem is to provide a vehicle motor drive device for efficiently controlling heat generation of an inverter and a motor, and a method for controlling the same.

The technical problems to be achieved in the exemplary embodiment are not limited to the technical problems mentioned above, and other technical problems that are not mentioned will be clearly understood by those skilled in the art to which the present disclosure belongs from the following description.

In an exemplary embodiment as a means for solving the above technical problems, there is provided a vehicle motor drive device, including: an inverter including a plurality of switching elements and connected to each winding of a motor; and a controller operatively connected to the inverter and configured to drive the motor by controlling the inverter, wherein the controller may be configured to control a magnitude and a frequency of a D-axis current applied to the motor based on a stopped state of a vehicle and a required heat generation quantity

In the exemplary embodiment of the present disclosure, the controller may be configured to apply the D-axis current in a recurring unit pattern in which the magnitude changes over time.

In the exemplary embodiment of the present disclosure, the D-axis current may be a triangular wave or a square wave.

In the exemplary embodiment of the present disclosure, the controller may be configured to control the magnitude and the frequency of the D-axis current based on specifications of the motor and specifications of the inverter.

In the exemplary embodiment of the present disclosure, the controller may be configured to control the magnitude of the D-axis current based on an internal current specification of each switching element.

In the exemplary embodiment of the present disclosure, the controller may be configured to control the magnitude and the frequency of the D-axis current based on a temperature of the motor and a temperature of the inverter.

In the exemplary embodiment of the present disclosure, the controller may be configured to control the magnitude and the frequency of the D-axis current based on a map including a first axis corresponding to the magnitude of the D-axis current and a second axis corresponding to the frequency of the D-axis current and where a heat generation quantity corresponds to an area defined by the first axis and the second axis, and the heat generation quantity may include a heat generation quantity of the motor and a heat generation quantity of the inverter.

In the exemplary embodiment of the present disclosure, the controller may be configured to control the frequency of the D-axis current to be less than or equal to half a switching frequency of the inverter.

In the exemplary embodiment of the present disclosure, the controller may be configured to control the frequency of the D-axis current when the vehicle is stopped, while maintaining a switching frequency of the inverter constant.

In the exemplary embodiment of the present disclosure, the controller may be configured to determine the required heat generation quantity based on a heat quantity required for heating a battery of the vehicle and a heat quantity required for heating the vehicle.

In an exemplary embodiment as another means for solving the e technical problem, there is provided a method for controlling a vehicle motor drive device, the method including: determining a stopped state of a vehicle; determining a required heat generation quantity based on concluding that the vehicle is in the stopped state; determining a magnitude and a frequency of a D-axis current applied to a motor based on the required heat generation quantity; and controlling an inverter connected to each winding of the motor to apply the determined D-axis current to the motor.

In the exemplary embodiment of the present disclosure, the D-axis current may have a unit pattern in which the magnitude varies over time.

In the exemplary embodiment the D-axis current may be a triangular wave or a square wave.

In the exemplary embodiment the determining of the magnitude and the frequency of the D-axis current may include determining the magnitude and the frequency of the D-axis current based on specifications of the motor and specifications of the inverter.

In the exemplary embodiment of the present disclosure, the determining of the magnitude and the frequency of the D-axis current may include determining the magnitude of the D-axis current based on an internal current specification of each switching element.

In the exemplary embodiment of the present disclosure, the determining of the magnitude and the frequency of the D-axis current may include determining the magnitude and the frequency of the D-axis current based on a temperature of the motor and a temperature of the inverter.

In the exemplary embodiment of the present disclosure, the determining of the magnitude and the frequency of the D-axis current may include determining the magnitude and the frequency of the D-axis current based on a map including a first axis corresponding to the magnitude of the D-axis current and a second axis corresponding to the frequency of the D-axis current and where a heat generation quantity corresponds to an area defined by the first axis and the second axis, and the heat generation quantity may include a heat generation quantity of the motor and a heat generation quantity of the inverter.

In the exemplary embodiment of the present disclosure, the determining of the magnitude and the frequency of the D-axis current may include determining the frequency of the D-axis current to be less than or equal to half a switching frequency of the inverter.

In the exemplary embodiment of the present disclosure, the applying of the D-axis current to the motor may include applying the D-axis current to the motor, while maintaining a switching frequency of the inverter constant.

In the exemplary embodiment of the present disclosure, the determining of the required heat generation quantity may include determining the required heat generation quantity based on a heat quantity required for heating a battery of the vehicle and a heat quantity required for heating the vehicle.

According to the exemplary embodiment of the present disclosure, when an electrified vehicle is stopped, the magnitude and the frequency of a direct current (DC) command may be appropriately determined to control the heat generation of an inverter and a motor. Such heat generation of the inverter and motor may be used for battery temperature increase and for heating, thereby improving the efficiency of a heating system of the electrified vehicle and increasing energy efficiency.

The effects of the present disclosure are not limited to the above-mentioned effect, and other objectives that are not mentioned will be clearly understood by those skilled in the art from the following description.

### BRIEF DESCRIPTION OF THE DRAWINGS

FIG. 1 is a block diagram illustrating an example of a vehicle motor drive device including an inverter, a motor, and a controller that is configured to control the inverter and the motor according to an exemplary embodiment of the present disclosure.

FIG. 2 is a graph illustrating an example of a triangle wave current command generated by a heat generation control unit according to the exemplary embodiment of the present disclosure.

FIG. 3 is a graph illustrating an example of a square wave current command generated by a heat generation control unit according to the exemplary embodiment of the present disclosure.

FIG. 4 is a graph illustrating an example of a process in which the heat generation control unit is configured to generate square wave current commands of different frequencies according to the exemplary embodiment of the present disclosure.

FIG. 5 is a flowchart illustrating an example of a process for determining whether a vehicle is stopped or not and controlling heat generation of an inverter and a motor when the vehicle enters a heat generation mode according to the exemplary embodiment of the present disclosure.

FIG. 6 is a graph illustrating an example of relationships between the magnitudes and frequencies of motor current and the heat generation quantities generated by iron loss of the motor according to the exemplary embodiment of the present disclosure.

### DETAILED DESCRIPTION

Hereinafter, an exemplary embodiment included in the present specification will be described in detail with reference to the accompanying drawings, but regardless of the reference numerals, the same or similar components are given the same reference numbers, and the overlapping description thereof will be omitted. The words “module” and “part/unit” used as noun suffixes for the components used in the following descriptions are given or mixed in consideration of only the ease of writing the specification, and the words do not have distinct meanings or roles by themselves. In describing the exemplary embodiment included in the present specification, when it is determined that a detailed description of a related known technology may obscure the subject matter of the exemplary embodiment included in the present specification, the detailed description thereof will be omitted. In addition, the accompanying drawings are only for easy understanding of the exemplary embodiment included in the present specification, and the technical idea included in the present specification is not limited by the accompanying drawings, so it should be understood that the accompanying drawings include all changes, equivalents, or substitutes, which are included in the spirit and technical scope of the present disclosure.

Terms including ordinal numbers such as first, second, etc. may be used to describe various components, but the components are not limited by the terms. These terms are only used for distinguishing one component from another component.

It will be understood that when a component is referred to as being “coupled” or “connected” to another component, it may be directly coupled or connected to the other component or intervening components may be present. In contrast, when a component is referred to as being “directly connected”, “directly coupled”, or “directly linked” to another component, it should be understood that there are no intervening components present therebetween.

As used herein, the singular forms are intended to include the plural forms as well, unless the context clearly indicates otherwise.

It will be further understood that when used in the present specification, the terms such as “comprise”, “include”, and “have” specify the presence of stated features, integers, steps, operations, elements, components, and/or combinations thereof, but do not preclude the presence or addition of one or more other features, integers, steps, operations, elements, components, and/or combinations thereof.

Furthermore, a unit or controller included in names such as a motor control unit (MCU) is just a term widely used for naming of a controller that is configured to control vehicle-specific functions, and does not mean a generic function unit. For example, each controller may include: a communication device for communicating with other controllers or sensors to control functions in charge; a memory for storing an operating system, logic instructions, and input/output information; and one or more processors for performing determinations, determinations, and decisions, which are required for controlling the functions in charge.

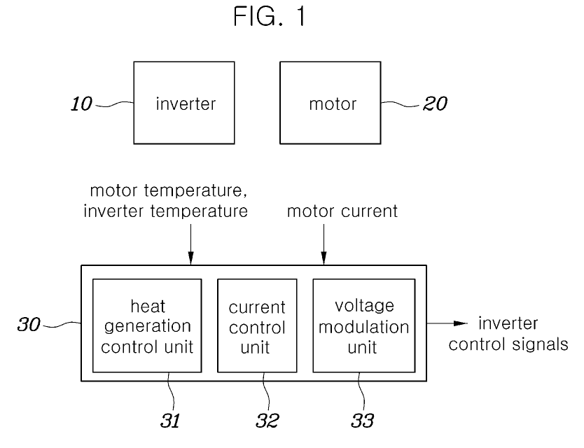

FIG. 1 is a block diagram illustrating an example of a vehicle motor drive device including an inverter, a motor, and a controller that is configured to control the inverter and the motor according to an exemplary embodiment of the present disclosure.

Referring to FIG. 1, a vehicle motor drive device according to an exemplary embodiment of the present disclosure may include an inverter 10, a motor 20, and a controller 30 that includes a heat generation control unit 31, a current control unit 32, and a voltage modulation unit 33.

The inverter 10 may include a plurality of switching elements respectively connected to a plurality of three-phase windings in the motor 20. The inverter 10 may receive input of direct current power from a battery and supply alternating current power to the motor 20 under the control of the controller 30.

For example, the controller 30 may be configured to generate a voltage command for independently controlling torque and flux of the motor 20 through a Direct Torque Control (DTC) method or a Field Orientation Control (FOC) method, and control each switching element on the basis of the present voltage command. As an example of the control method, the controller 30 may be configured for controlling the ON/OFF state of each switching element through a Space Vector Pulse Width Modulation (SVPWM) technique. In the present way, the speed and torque of the motor 20 may be controlled by converting a DC voltage input from a battery into a three-phase AC voltage and supplying the converted voltage to each phase of the motor 20. Hereinafter, for convenience of description, it is assumed that the controller 30 according to the exemplary embodiment of the present disclosure is configured to control the motor 20 by use of the Field Orientation Control (FOC) method and the Space Vector Pulse Width Modulation (SVPWM) technique.

The heat generation control unit 31 of the controller 30 may be configured to generate a current command on the basis of a total required heat generation quantity by considering a heat quantity required for battery temperature increase in a vehicle when the vehicle is stopped and a heat quantity required for vehicle heating, and transmit the current command to the current control unit. The current command generated by the heat generation control unit 31 will be described in detail below.

The current control unit 32 of the controller 30 may receive the current command and a motor current value and then generate a voltage command. For example, the current control unit 32 may receive both of the current command and the motor current value measured in real time and generate the voltage command through feedback control to maximally reduce a difference therebetween. As an example of the feedback control, a Proportional-Integral Control (PI Control) technique may be used. The current command may include both a current command received from the heat generation control unit 31 and a current command received from another controller, but the following description will assume that all current commands received when the vehicle is stopped are received from the heat generation control unit 31.

The voltage modulation unit 33 of the controller 30 may receive a voltage command from the current control unit 32 and generate an inverter control signal. For example, the voltage modulation unit 33 may receive a D-axis voltage command and a Q-axis voltage command, which are generated by the current control unit 32, convert them into a three-phase voltage command, and apply the SVPWM technique, to generate the inverter control signal for controlling a switching element of the inverter 10.

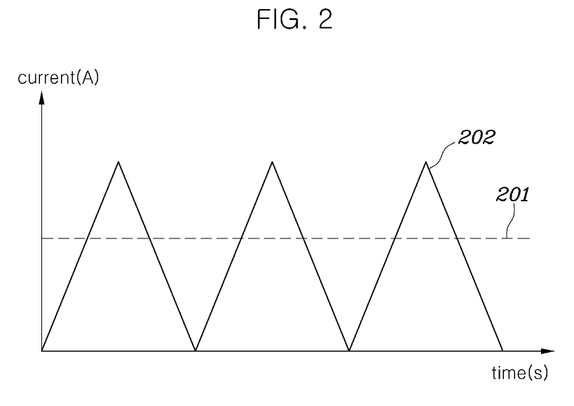

Hereinafter, referring to FIGS. 2, 3 and 4, several examples of current commands generated by the heat generation control unit 31 will be described.

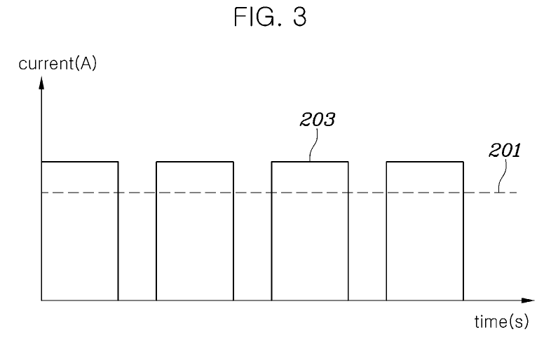

FIG. 2 is a graph illustrating an example of a triangle wave current command generated by a heat generation control unit according to the exemplary embodiment of the present disclosure. FIG. 3 is a graph illustrating an example of a square wave current command generated by a heat generation control unit according to the exemplary embodiment of the present disclosure.

Referring to FIGS. 2 and 3, the heat generation control unit 31 may be configured for controlling the heat generation of an inverter 10 and a motor 20 by generating a current command 201 in which the magnitude of a D-axis current in a synchronous coordinate system is constant regardless of time. In the instant case, heat generation due to copper loss of the motor, conduction loss of the inverter, switching loss of the inverter, etc. may occur, but heat generation due to iron loss of the motor may not occur easily.

In contrast, the heat generation control unit 31 may be configured for controlling the heat generation of the inverter 10 and motor 20 by generating a current command whose magnitude of a D-axis current changes over time. For example, the heat generation control unit 31 may be configured to generate a triangular wave current command 202 having a constant frequency. In the instant case, since the magnitude of magnetic flux inside the motor changes over time, not only heat generation due to the copper loss of the motor, the conduction loss of the inverter, and the switching loss of the inverter may occur, but also heat generation due to the iron loss of the motor may occur. Accordingly, for current commands with the same root mean square (RMS) value, a heat generation quantity generated by the triangular wave current command 202 may be greater than a heat generation quantity generated by the constant-magnitude current command 201.

Referring to FIG. 3, the heat generation control unit 31 may also generate a square wave current command 203 having a constant frequency for the heat generation of the inverter 10 and motor 20. Furthermore, the heat generation control unit 31 may be configured to generate various types of current commands, including triangular-wave current commands and square-wave current commands, depending on motor design forms and specifications, to control the heat generation in the motor and the inverter.

In a case where there is no torque required for the motor due to the stop of the vehicle, the heat generation control unit 31 may be configured for controlling a Q-axis current component among current commands to become zero.

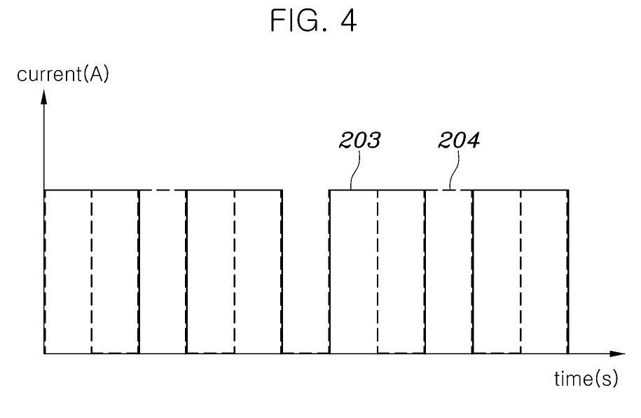

FIG. 4 is a graph illustrating an example of a process in which the heat generation control unit is configured to generate square wave current commands of different frequencies according to the exemplary embodiment of the present disclosure.

Referring to FIG. 4, the heat generation control unit 31 may vary the frequency of a current command to control the heat generation of the inverter 10 and motor 20. The iron loss of the motor 20 may increase as not only the magnitude of the current command increases but also the frequency of the current command increases. Accordingly, regarding current commands with the same Root Mean Square (RMS) value, the quantity of heat generated by the iron loss of the motor may be larger in a case where the frequency of a current command 204 is greater than the relatively small frequency of a current command 203.

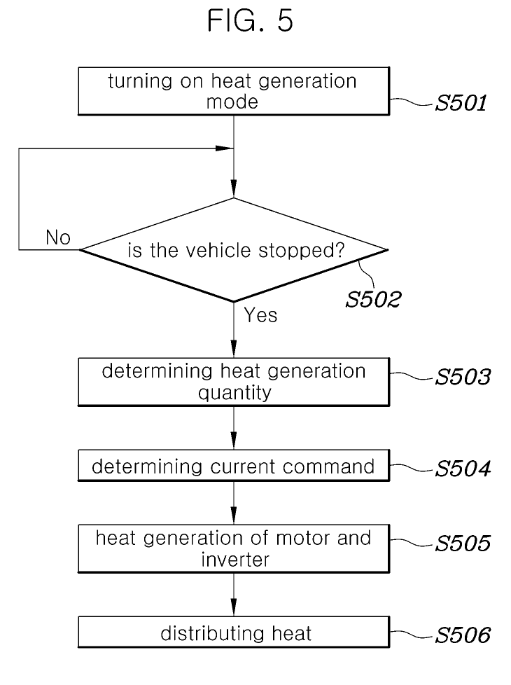

FIG. 5 is a flowchart illustrating an example of a process of the controller 30 for determining whether a vehicle is stopped and controlling heat generation of an inverter and a motor when the vehicle enters a heat generation mode according to the exemplary embodiment of the present disclosure.

In step S501, the vehicle may enter a heat generation mode to obtain both a heat quantity required for battery temperature increase and a heat quantity for vehicle heating from the heat generation of the motor. The vehicle may be configured to determine whether it is in a stopped state or not through another internal controller in step S502 and transmit the stopped state of the vehicle to a controller 30. As an exemplary embodiment of the present disclosure, the controller 30 may also directly obtain a wheel speed from a wheel speed sensor, to determine whether the vehicle is in the stopped state.

In a case where the vehicle is determined to be stopped (“Yes” in step S502), a heat generation control unit 31 in the controller 30 may be configured to determine a required heat generation quantities of the motor and an inverter on the basis of a heat quantity for the battery temperature increase and vehicle heating in step S503. For example, the heat quantity for the battery temperature increase may be determined on the basis of a battery temperature obtained through a temperature sensor in a battery, and the heat quantity for the heating may be determined on the basis of a heating temperature set by a driver, thereby determining the total required heat generation quantity.

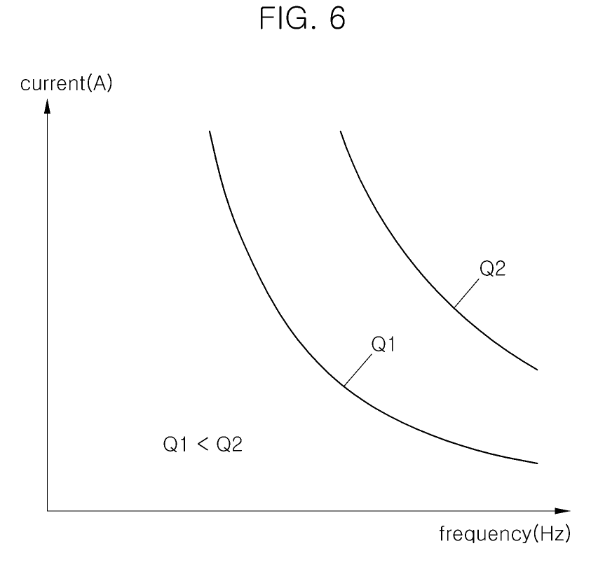

In step S504, the heat generation control unit 31 may be configured to determine what kind of current command to generate on the basis of the required heat generation quantity, inverter and motor specifications, and inverter and motor temperatures, which are previously determined. A more detailed determination process will be described below along with FIG. 6.

A current control unit 32 and a voltage modulation unit 33 may be configured to generate an inverter control signal on the basis of a current command. In the present way, current may flow to the inverter 10 and the motor 20, and in step S505, heat generation may occur.

Furthermore, in step S506, through a distributor such as a valve in the vehicle, the heat generation quantities of the inverter 10 and motor 20 may be distributed to areas where heat quantities are required. For example, a battery heater for battery temperature increase and a heating device for heating may be removed, and the heat obtained from the inverter 10 and motor 20 may be distributed through an integrated valve.

In the flowchart described with reference to the drawings, the flowchart may be performed by the controller or the processor. The order of operations in the flowchart may be changed, multiple operations may be merged, or any operation may be divided, and a specific operation may not be performed. In addition, the operations in the flowchart may be performed sequentially, but not necessarily performed sequentially. For example, the order of the operations may be changed, and at least two operations may be performed in parallel.

In the above, the process is described, in which the heat generation control unit 31 generates the D-axis current command in the stationary situation of the vehicle and is configured to control the heat generation of the inverter 10 and motor 20 accordingly. Hereinafter, a process of determining an appropriate current command is described through relationships between the magnitudes and frequencies of current commands and the quantities of heat generated by the motor.

FIG. 6 is a graph illustrating an example of relationships between the magnitudes and frequencies of motor current and the heat generation quantities generated by the iron loss of the motor according to the exemplary embodiment of the present disclosure.

Referring to FIG. 6, as the magnitude of a motor current increases or the frequency of current increases, a quantity of heat generated due to the iron loss of the motor may increase (Q1 < Q2). Since the combination of the magnitudes and frequencies of current commands to satisfy a required heat generation quantity (e.g., Q1) may be diverse, the heat generation control unit 31 may be configured to determine a magnitude and frequency of a current command on the basis of the specifications and temperatures of the inverter 10 and motor 20.

For example, in a case where the required heat generation quantity increases (Q1 → Q2 in FIG. 6), the controller 30 may maintain the magnitude of the current command but only increase the frequency of the current command to prevent the magnitude of the current command from becoming greater than that of an internal current specification of the inverter. At the instant time, a switching frequency for controlling the ON/OFF state of a switching element in the inverter 10 may be maintained constant despite the change in the frequency of the current command.

As an exemplary embodiment of the present disclosure, the controller 30 may also increase a heat generation quantity by limiting the frequency of a current command to be less than or equal to half of the switching frequency of the inverter (i.e., the Nyquist frequency) to prevent an aliasing effect, and by only increasing the magnitude of the current command.

Furthermore, since the heat generation quantities of the inverter 10 and motor 20 may vary depending on current command waveforms for current commands including the same Root Mean Square (RMS) value, a current command waveform may be appropriately selected according to their specifications.

Although an exemplary embodiment of the present disclosure has been described for illustrative purposes, those skilled in the art will appreciate that various modifications, additions, and substitutions are possible, without departing from the technical scope and spirit of the present disclosure as included in the accompanying claims.

What is claimed is:

1. A vehicle motor drive device comprising:
an inverter including a plurality of switching elements and connected to each winding of a motor; and
a controller operatively connected to the inverter and configured to drive the motor by controlling the inverter,
wherein the controller controls a magnitude and a frequency of a D-axis current applied to the motor based on a stopped state of a vehicle and a required heat generation quantity.

2. The vehicle motor drive device of claim 1, wherein the controller applies the D-axis current in a recurring unit pattern in which the magnitude changes over time.

3. The vehicle motor drive device of claim 2, wherein the D-axis current is a triangular wave or a square wave.

4. The vehicle motor drive device of claim 1, wherein the controller controls the magnitude and the frequency of the D-axis current based on specifications of the motor and specifications of the inverter.

5. The vehicle motor drive device of claim 4, wherein the controller controls the magnitude of the D-axis current based on an internal current specification of each switching element.

6. The vehicle motor drive device of claim 1, wherein the controller controls the magnitude and the frequency of the D-axis current further based on a temperature of the motor and a temperature of the inverter.

7. The vehicle motor drive device of claim 1,
wherein the controller controls the magnitude and the frequency of the D-axis current based on a map having a first axis corresponding to the magnitude of the D-axis current and a second axis corresponding to the frequency of the D-axis current and wherein a heat generation quantity corresponds to an area defined by the first axis and the second axis, and
wherein the heat generation quantity includes a heat generation quantity of the motor and a heat generation quantity of the inverter.

8. The vehicle motor drive device of claim 7, wherein the controller controls the frequency of the D-axis current to be less than or equal to half a switching frequency of the inverter.

9. The vehicle motor drive device of claim 1, wherein the controller controls the frequency of the D-axis current while maintaining a switching frequency of the inverter constant.

10. The vehicle motor drive device of claim 1, wherein the controller determines the required heat generation quantity based on a heat quantity required for heating a battery of the vehicle and a heat quantity required for heating the vehicle.

11. A method for controlling a vehicle motor drive device, the method comprising:
determining, by a controller, a stopped state of a vehicle;
determining, by the controller, a required heat generation quantity based on concluding that the vehicle is in the stopped state;
determining, by the controller, a magnitude and a frequency of a D-axis current applied to a motor based on the required heat generation quantity; and
controlling, by the controller, an inverter connected to each winding of the motor and operatively connected to the controller to apply the determined D-axis current to the motor.

12. The method of claim 11, wherein the D-axis current includes a unit pattern in which the magnitude varies over time.

13. The method of claim 12, wherein the D-axis current is a triangular wave or a square wave.

14. The method of claim 11, wherein the determining of the magnitude and the frequency of the D-axis current further comprises:
determining the magnitude and the frequency of the D-axis current based on specifications of the motor and specifications of the inverter.

15. The method of claim 14, wherein the determining of the magnitude and the frequency of the D-axis current further comprises:
determining the magnitude of the D-axis current based on an internal current specification of each switching element.

16. The method of claim 11, wherein the determining of the magnitude and the frequency of the D-axis current further comprises:
determining the magnitude and the frequency of the D-axis current by further based on a temperature of the motor and a temperature of the inverter.

17. The method of claim 11,
wherein the determining of the magnitude and the frequency of the D-axis current further comprises:
determining the magnitude and the frequency of the D-axis current based on a map having a first axis corresponding to the magnitude of the D-axis current and a second axis corresponding to the frequency of the D-axis current, wherein a heat generation quantity corresponds to an area defined by the first axis and the second axis, and
wherein the heat generation quantity comprises a heat generation quantity of the motor and a heat generation quantity of the inverter.

18. The method of claim 17, wherein the determining of the magnitude and the frequency of the D-axis current further comprises:
determining the frequency of the D-axis current to be less than or equal to half a switching frequency of the inverter.

19. The method of claim 11, wherein the applying of the D-axis current to the motor further comprises:
applying the D-axis current to the motor, while maintaining a switching frequency of the inverter constant.

20. The method of claim 11, wherein the determining of the required heat generation quantity further comprises:
determining the required heat generation quantity based on a heat quantity required for heating a battery of the vehicle and a heat quantity required for heating the vehicle.
